(19) United States
(12) Patent Application Publication
(10) Pub. No.: US 2016/0280560 A1
(43) Pub. Date: Sep. 29, 2016

(54) METHOD OF LASER TREATING A ZIRCONIA SURFACE

(71) Applicant: KING FAHD UNIVERSITY OF PETROLEUM AND MINERALS, DHAHRAN (SA)

(72) Inventors: BEKIR SAMI YILBAS, DHAHRAN (SA); HAIDER ALI, DHAHRAN (SA)

(21) Appl. No.: 15/076,597

(22) Filed: Mar. 21, 2016

Related U.S. Application Data
(60) Provisional application No. 62/137,213, filed on Mar. 23, 2015.

(51) Int. Cl. C01G 25/02

(52) U.S. Cl. CPC C01G 25/02

(57) ABSTRACT

A method of laser treating a zirconia surface can include surface texturing zirconia using a combination of ablation and melting. The method includes forming a carbon film on the zirconia surface and laser treating the carbon-coated zirconia surface. The carbon film can include titanium carbide (TiC) and boron carbide (B₄C), for example. The carbon film can include titanium carbide (TiC) and boron carbide (B₄C) in equal proportions. The carbon-coated surface can then be scanned with a nitrogen gas-assisted CO₂ laser beam to form a laser-treated surface. The laser-treated surface can include ZrN compounds. The present method can enhance the surface properties of zirconia and improve the structural integrity of zirconia.

### CROSS-REFERENCE TO RELATED APPLICATION

This application claims the benefit of U.S. Provisional Patent Application Ser. No. 62/137,213, filed on Mar. 23, 2015.

### BACKGROUND OF THE INVENTION

1. Field of the Invention

The present invention relates to the laser treatment of surfaces, and particularly to a method of laser treating a zirconia surface.

2. Description of the Related Art

Zirconia tiles are mainly manufactured from powder forms through sintering. Zirconia (ZrO₂) is usually doped with a small fraction (2-3%) of yttria (Y₂O₃) to conserve ZrO₂ (cubic (c-ZrO₂) or tetragonal (t-ZrO₂)) high temperature phases down to room temperature. Since zirconia has high melting temperature, thermal processing of zirconia tiles is difficult and costly during tile production. In addition, zirconia powders are hard to sinter and mico/nanosize pores are left open in tiles produced.

Thus, a method of laser texturing a zirconia surface addressing the aforementioned problems is desired.

### SUMMARY OF THE INVENTION

A method of laser texturing a zirconia surface can include surface texturing zirconia using a combination of ablation and melting. The method includes forming a carbon film on the zirconia surface and laser treating the carbon-coated zirconia surface. The carbon film can include titanium carbide (TiC) and boron carbide (B₄C), for example. The carbon film can include titanium carbide (TiC) and boron carbide (B₄C) in equal proportions. The carbon-coated surface can then be scanned with a nitrogen gas-assisted CO₂ laser beam to form a laser-treated surface. The laser-treated surface can include ZrN compounds. The present method can enhance the surface properties of zirconia, e.g., providing improved corrosion resistance and wear resistance, and improve the structural integrity of zirconia.

These and other features of the present invention will become readily apparent upon further review of the following specification and drawings.

### BRIEF DESCRIPTION OF THE DRAWINGS

FIG. 1A is a scanning electron micrograph of a zirconia surface prepared by a method of laser texturing a zirconia surface according to the present invention, specifically showing regular laser scanning tracks.

FIG. 1B is a scanning electron micrograph of a zirconia surface prepared by the method of laser texturing a zirconia surface, specifically showing overlapping of laser irradiated pulses at the surface.

FIG. 1C is a scanning electron micrograph of a zirconia surface prepared by the method of laser texturing a zirconia surface, specifically showing the microtexture/nanotexture at the surface.

FIG. 1D is a scanning electron micrograph of a zirconia surface prepared by the method of laser texturing a zirconia surface, specifically showing partially embedded hard particles and fine-sized cavities formed in the surface.

FIG. 2A is an optical image of a water droplet on the zirconia surface prepared by the method of laser texturing a zirconia surface.

FIG. 2B is an optical image of a water droplet on an untreated zirconia surface.

FIG. 3A is a scanning electron micrograph of a laser-treated layer of the zirconia surface prepared by the method of laser texturing a zirconia surface, specifically showing a depth of the treated layer.

FIG. 3B is a scanning electron micrograph of a laser-treated layer of the zirconia surface prepared by the method of laser texturing a zirconia surface, specifically showing the treated layer forming a dense surface consisting of small grains and hard particles.

FIG. 3C is a scanning electron micrograph of a laser-treated layer of the zirconia surface prepared by the method of laser texturing a zirconia surface, specifically showing a pin hole-like void formed around hard particles therein.

FIG. 3D is a scanning electron micrograph of a laser-treated layer of the zirconia surface prepared by the method of laser texturing a zirconia surface, specifically showing the formation of dendritic structures.

FIG. 3E is a scanning electron micrograph of a laser-treated layer of the zirconia surface prepared by the method of laser texturing a zirconia surface, specifically showing the formation of columnar structures.

FIG. 3F is a scanning electron micrograph of a laser-treated layer of the zirconia surface prepared by the method of laser texturing a zirconia surface, specifically showing the interface between the treated layer and the base zirconia material.

FIG. 4 is an X-ray diffractogram of the zirconia surface prepared by the method of laser texturing a zirconia surface.

FIG. 5 is a graph showing a comparison of the friction coefficient of the zirconia surface prepared by the method of laser texturing a zirconia surface against the friction coefficient of an untreated zirconia surface.

Similar reference characters denote corresponding features consistently throughout the attached drawings.

### DETAILED DESCRIPTION OF THE PREFERRED EMBODIMENTS

A method of laser treating a zirconia surface can include using a combination of ablation and melting. The zirconia surface can be an ytrria-stabilized zirconia tile surface. The method includes forming a carbon film on the zirconia surface and laser treating the carbon-coated zirconia surface. The carbon film can include at least two chemically different hard particle types. The hard particles can include titanium carbide (TiC) and boron carbide (B₄C), for example. The hard particles can each have a particle size of about 600 nm. The carbon film can include titanium carbide (TiC) and boron carbide (B₄C) in equal proportions. The carbon-coated surface can then be scanned with a nitrogen gas-assisted CO₂ laser beam to form a laser-treated surface. The laser-treated surface can include ZrN compounds. The laser-treated surface can be hydrophobic. The laser-treated surface can be free or substantially free from cracks and/or crack networks. The laser-treated surface can have a friction coefficient that is less than the untreated zirconia surface. Surface treatment of a zirconia surface, e.g., yttria-stabilized tetragonal zirconia, enhances surface properties and improves the structural integrity at the surface.

The carbon film can increase the absorption of the laser beam at the irradiated surface and uniformly distribute the mixture including the hard particles. A phenolic resin and hard particle mixture can be provided to form the carbon film at the zirconia surface. The phenolic resin and hard particle mixture can be prepared by adding a mixture of at least two chemically different hard particle types, e.g., titanium carbide (TiC) and boron carbide (B₄C), to water dissolved phenolic resin. Hard particles can include any suitable powder with high melting points and high hardness. Other examples of hard particles include AlO₂, TiN, and VC. The phenolic resin and hard particle mixture is applied to the zironia surface and heated under pressure, e.g., 175° C. for 2 hours under 8 bar pressure, then 400° C. in an argon environment for several hours, to form the carbon film. The carbon film can have a thickness of about 40 μm.

The laser gas assisted processing of the coated surface modifies the surface chemistry and microstructure at the surface. For example, the peak intensity of the laser pulse can be at the irradiated spot center. This can cause evaporation in the region limited to the irradiated spot center, while regions adjacent to the irradiated spot center decay, resulting in melting. One or more fine-sized cavities can be formed at the irradiated spot center and the melt flow from adjacent areas modifies the shape and depth of the one or more cavities. The combination of surface ablation and melting gives rise to a surface texture including micro/nanopoles and cavities. The gas can be an inert gas, e.g., nitrogen. The laser nitrogen gas-assisted processing of the surface forms zirconia nitride (ZrN) in the irradiated surface region. The use of high energy lasers for surface treatment offers considerable advantages, including local treatment, short processing time, and precise operation. The present method improves the wear resistance of the zirconia surface.

In experiment, 15 mm×13 mm×3 mm zirconia tiles were used. The water soluble phenolic resin was mixed with 3 wt % of TiC and 3 wt % B₄C powders of about 600 nm particle size, with homogeneous mixing. A uniform phenolic resin coating, containing the mixture of 3 wt % of TiC and 3 wt % B₄C powders, with a thickness of 40 μm, was formed on each tile surface in a control chamber at 8 bar pressure and 175° C. for two hours. The workpieces were then heated to 400° C. in an argon environment for several hours to ensure the conversion of the phenolic resin into carbon.

The carbon film coated zirconia tiles were scanned by the laser beam in the presence of the high pressure nitrogen assisting gas. A CO₂ laser delivering a nominal output power of 2 kW at pulse mode with different frequencies was used to irradiate the resin-coated workpiece surface. The nominal focal length of the focusing lens was 127 mm. The laser beam diameter focused at the workpiece surface was 0.2 mm. Nitrogen assisting gas emerged from a conical nozzle, co-axially with the laser beam. It should be noted that the laser surface ablation/melting process was carried out with a variety of laser parameters. Reducing the laser output power below 2 kW resulted in high surface roughness due to melt flow over the surface. In addition, reducing laser scanning speed below 10 cm/s increased the surface roughness due to over-melting at the surface. Alternatively, evaporation at the surface ceased and melting took place along the scanning tracks with increased laser scanning speed beyond 10 m/s. Optimal laser parameters for surface ablation with low surface roughness included a feed rate of 0.1 m/s, a power of 2 kW, a peak power intensity of 6.37×10¹⁰ W/m², a frequency of 1.5 kHz, a nozzle gap of 1.5 mm, a nozzle diameter of 1.5 mm, a focus diameter of 0.3 mm, and an N₂ pressure of 600 kPa.

A scanning electron microscope (SEM) was used to obtain photomicrographs of the cross-section and surface of each workpiece after the tests. Energy-dispersive spectroscopy (EDS) analysis was carried out for eight different locations at the laser treated surface. The error related to the EDS analysis was estimated based on the repeatability of the data, which was found to be on the order of 3%. X-ray diffraction (XRD) analysis was also carried out (Cu-Kα; λ=1.5406 Å) using XRD equipment with a Bragg-Brentano geometry arrangement. A typical setting of the XRD equipment was 40 kV and 30 mA.

A microphotonics digital hardness tester was used to obtain Vickers micro-indentation hardness values at the ablated surface. The standard test method for Vickers indentation hardness of advanced ceramics (ASTM C1327-99) was adopted. Microhardness was measured at the workpiece surface after the laser ablation/melting process. The measurements were repeated five times at each location for consistency of the results.

A linear micro-scratch tester was also used to determine the friction coefficient of the laser ablated/melted and “as received” (i.e., untreated) surfaces. The equipment was set at a contact load of 0.03 N and an end load of 5 N. The scanning speed was 5 mm/min and the loading rate was 5 N/min. The total length for the scratch tests was 5 mm.

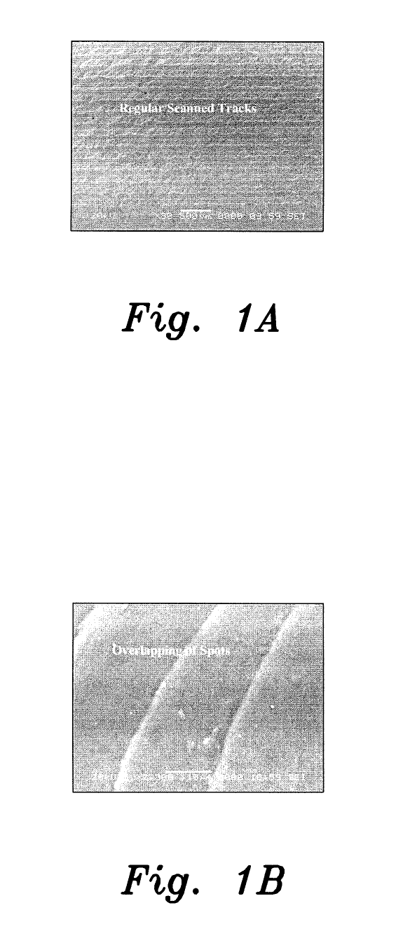

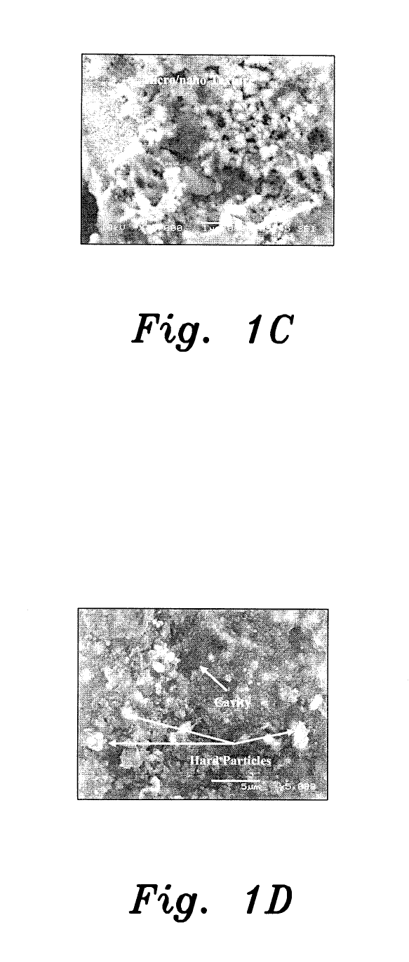

FIGS. 1A-1D show SEM micrographs of the laser treated surface. Since laser repetitive pulses were used during laser scanning of the workpiece surface at 0.1 m/s, regular laser tracks are formed at the surface, as shown in FIG. 1A. The overlapping ratio of laser irradiated spots is almost 72% at the workpiece surface, as shown in FIG. 1B. FIG. 1C shows the microtexture/nanotexture at the surface, and FIG. 1D shows partially embedded hard particles and fine-sized cavities formed in the surface. The laser pulse intensity distribution is Gaussian, which results in the peak intensity at the irradiated spot center. This causes surface evaporation in the region limited to the irradiated spot center and the region in the neighborhood of the irradiated spot center, where laser intensity decays, thus resulting in melting in this region. Therefore, a fine size cavity is formed at the irradiated spot center and the melt flow from its neighborhood modifies the cavity shape and its depth. The combination of surface ablation and melting gives rise to the surface texture formed of micropoles/nanopoles and cavities. This morphology can be seen in FIG. 1C.

The surface roughness increases slightly due to the presence of locally scattered and partially embedded hard particles. Since the hard particle size is small (0.6 μm), the increase in the surface roughness is not substantial. A close examination of the SEM micrograph shown in FIG. 1D reveals that partially embedded hard particles are evident at the surface. This is attributed to the high melting temperature of the carbide particles (the melting temperature for TiC is 3430 K and is 3036 K for B₄C) incorporated in the surface texturing. The use of the high pressure nitrogen assisting gas increases convection cooling at the surface, which contributes to the formation of fine size grains at the surface. Since thermal expansion coefficients of the hard particles and the material are different, micro-stresses are formed in the near regions of the hard particles upon solidification of the substrate material because of contraction. However, micro-cracks are not observed around the hard particles, which indicates that stress levels formed in the near region of the hard particles are not sufficiently high to cause micro-cracking or crack network formation. Thus, the laser treated surface is free from asperities, including large size cavities and cracks.

Since the laser ablated surface is chemically heterogeneous because of the presence of hard particles and structurally inhomogeneous due to a non-hierarchal structured microsize/nanosize texture, the application of Young's equation is limited to assess the contact angle. The relationship between the contact angle of a liquid droplet and the surface roughness factor to overcome this limitation considers the liquid penetration into the rough grooves and expresses the contact angle as cos

$$cos {θ}_{w} = \frac{r ( {γ}_{sv} - {γ}_{sl} )}{{γ}_{lv}} ,$$

where θ_{w} is the rough surface contact angle, γₛᵥ is the interfacial tension of the solid-vapor interface, γₛₗ is the interfacial tension of the solid-liquid interface, γₗᵥ is the interfacial tension of the liquid-vapor interface, and r is the surface roughness factor, which is defined as the ratio between the actual and projected surface areas, where r=1 for a perfectly smooth surface and r>1 for a rough surface.

The contact angle equation can be further modified in terms of surface fraction of solid-liquid and liquid-vapor fractions as cos θ_{c}=f₁ cos θ₁+f₂ cos θ₂, where θ_{c} is the apparent contact angle, fₗ is the surface fraction of the liquid-solid interface, f₂ is the surface fraction of the liquid-vapor interface, θ₁ is the contact angle of the liquid-solid interface, and θ₂ is the contact angle for liquid-vapor interface. In the case of an air-liquid interface, f₁ is the solid-liquid fraction, and air fraction f₂ becomes (1−f₁). For f₁=0, the liquid droplet is not in contact with the solid surface and for f₁=1, the droplet completely wets the surface.

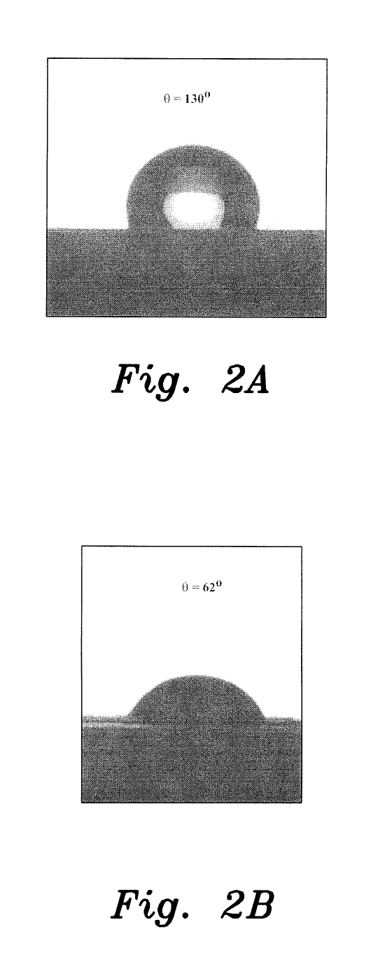

FIGS. 2A and 2B show optical images of the water droplet on the laser textured and “as received” (i.e., untreated) surfaces, respectively. For the laser ablated surface, the contact angle at the first location was 132°±5° and was 129°±5° at the second location. For the untreated surface, the contact angle at the first location was 61°±5° and was 63°±5° at the second location. Since the surface texture is non-uniform due to semi-embedded hard particles and varying microsize/nanosize poles and cavities, the contact angle varies slightly at different locations on the surface. In general, laser surface texturing results in formation of hydrophobic surface and the average contact angle of the surface is on the order of 130°. Therefore, surface texturing, due to a combination of ablation and melting, gives rise to the formation of fine pillars and poles of microscale/nanoscale at the surface, which in turn results in large contact angles of the water droplet.

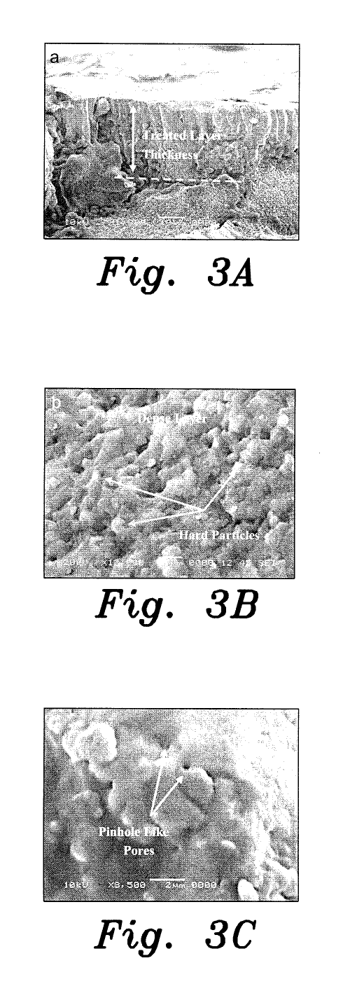

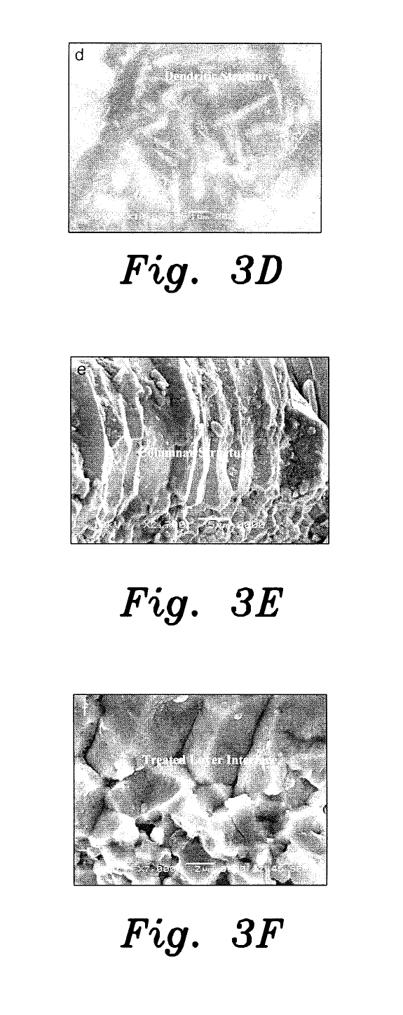

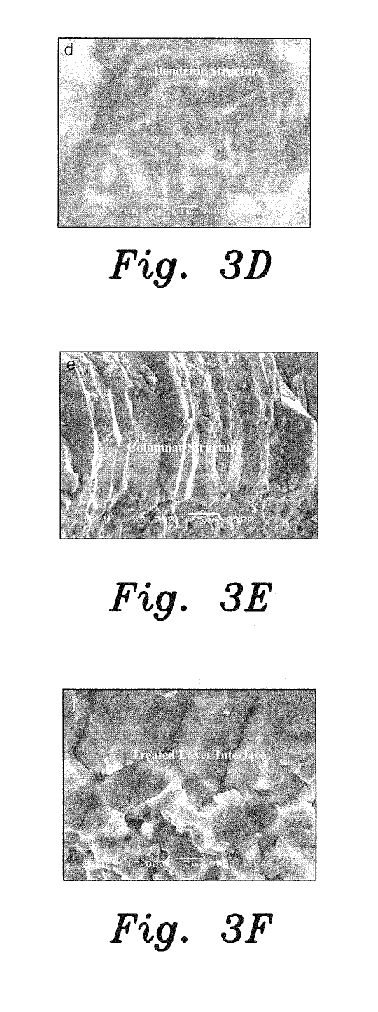

FIGS. 3A-3F show SEM micrographs of cross-sections of the laser treated layer. Although the high cooling rates in the surface region result in high temperature gradients and high stress levels in the treated layer, no cracks are observed in the laser treated layer. This is attributed to the self-annealing effect created during the laser scanning process, which in turn modifies the cooling rates below the surface in the laser treated layer. It should be noted that heat conduction from the newly formed laser scanning tracks towards the previously formed laser tracks alters the cooling rates in the surface vicinity while creating a self-annealing effect in this region. Moreover, the laser treated layer consists of mainly two regions, as shown in FIG. 3A. The first region represents the surface vicinity, where a dense structure formed of fine grains is formed (as seen in FIG. 3B). This is attributed to the high cooling rates at the surface, where convection cooling from the surface due to the assisting gas contributes to the cooling rates in the surface region.

A close examination of the SEM micrograph of FIG. 3C reveals that a pin hole-like void is formed in the close region of the hard particle below the surface. This is associated with the volume shrinkage due to the mismatch of thermal expansion coefficients of the hard particles and zirconia. However, the fine size void formation is limited and does not cover the large area in the surface vicinity. In the neighborhood of the surface vicinity, feather-like and dendritic structures are formed, as shown in FIG. 3D. In this case, the low cooling rates (which are relatively lower than that at the surface) are responsible for the formation of dendritic structures in this region. As the depth below the surface increases, columnar structures are formed, as seen in FIG. 3E, which is related to relatively lower cooling rates compared to those at the surface vicinity. However, no heat-affected zone is observed between the laser treated layer and the base material because of the low thermal conductivity of zirconia, as shown in FIG. 3F.

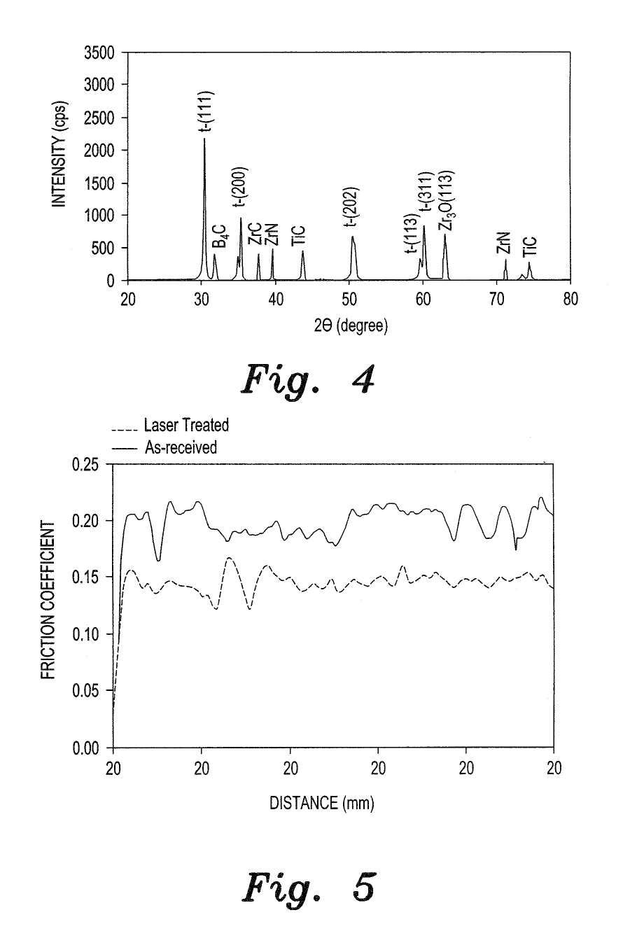

FIG. 4 shows the XRD diffractogram of the laser ablated/melted workpiece surface. It should be noted that t-ZrO₂, ZrN, B₄C and TiC peaks are identified in accordance with ICDD Card no. 042-1164, ICDD Card no. 035-753, ICDD Card no. 035-0784, ICDD Card no. 35-0798, and ICDD Card no. 032-1383, respectively. The peaks of tetragonal ZrO₂ (t-ZrO₂), TiC, B₄C, and the ZrN peaks are apparent in the diffractogram, and are usually formed in two steps. The transformation of the tetragonal structure of zirconia (t-ZrO₂) into cubic zirconia (c-ZrO₂) occurs in the first step due to high temperature processing. In the second step, oxygen released during the dissociation process causes zirconium nitride (ZrN) formation. The process can be written as t-ZrO₂→c-ZrO₂ and 2ZrO₂+N₂→2ZrN+2O₂ reactions.

Table 1 below provides the EDS data obtained for the laser treated surface. Error occurs for the quantification of light elements, such as nitrogen, from the EDS data, however, the presence of nitrogen is evident from the EDS data, as it is in the XRD diffractogram as the ZrN compound formed in the surface region. The error related to the EDS measurements is on the order of 3%.

TABLE 1
EDS Data for Elemental Composition at Surface (wt %)

| Spectrum | Y | Ti | B | N | Zr |
|---|---|---|---|---|---|
| Spectrum 1 | 2.7 | 3.2 | 2.8 | 7.1 | Balance |
| Spectrum 2 | 2.6 | 2.8 | 2.9 | 6.3 | Balance |

The fracture toughness of the surface is measured using the indenter test data for microhardness (Vickers) and crack inhibition. In this case, microhardness (in HV) and the crack length generated due to indentation at the surface were measured. The length of the cracks measured, l, corresponded to the distance from the crack tip to the indent. The crack lengths were individually summed to obtain Σl. The crack length, c, from the center of the indent is the sum of individual crack lengths, Σl, and half the indent diagonal length, 2a. Therefore, c=a+Σl. However, depending on the ratio of c/a, various equations were developed to estimate the fracture toughness, K. The following equation was used to determine the fracture toughness, K, and is applicable for

$$0.6 \leq \frac{c}{a} \leq 4.5 \text{:} {K}_{c} = 0.079 {( \frac{P}{a} )}^{1.5} log ( 4.5 P \cdot \frac{a}{c} ) ,$$

where P is the applied load on indenter, c is the crack length, and a is the half indent diagonal length.

Table 2 below gives fracture toughness and microhardness of the laser textured surface. Fracture toughness of the laser treated surface reduces slightly, from 9.2 MPa \sqrt{m} (untreated) to 6.8 MPa \sqrt{m} (laser textured), which is associated with the thermally induced stresses formed at the surface due to high cooling rates and microstresses formed due to the mismatch between the thermal expansion coefficients of the hard particles and the base material. Microhardness of the laser treated surface increased from 1600±20 HV (base material hardness) to 1900±40 HV due to the formation of a dense layer consisting of fine grains and feather-like structures, and the formation of the ZrN compound in the surface vicinity. In addition, the presence of hard particles contributes to surface hardness, however they only form a total of 6% at the surface and, thus, do not cover a large area at the surface. Consequently, quantification of their contribution to microhardness enhancement is difficult to assess. Nevertheless, comparison of microhardness data obtained from previous studies (1850 HV) indicates that the presence of hard particles improves surface microhardness slightly (+50 HV).

TABLE 2
Fracture Toughness and Elastic Modulus

| | Fracture | | | | | | |
|---|---|---|---|---|---|---|---|
| | Toughness | H | Stress | E | | a | c |
| | (MPa \sqrt{m}) | (HV) | (GPa) | (GPa) | ν | (μm) | (μm) |
| Untreated | 9.2 ± 0.4 | 1600 | 15.7 | 220 ± 5 | 0.27 | 20 | 50 |
| surface | | | | | | | |
| Treated | 6.8 ± 0.4 | 1900 | 18.6 | 360 ± 5 | 0.27 | 25 | 70 |
| surface | | | | | | | |

The XRD technique was used to measure the residual stresses in the surface region of the laser ablated surface. The XRD technique provided data in the surface region of the specimens due to the low penetration depth of Cu-Kα radiation into the treated layer; i.e., the penetration depth was on the order of few μm. The magnitude of the shift in the diffraction peaks could be related to the magnitude of the residual stress. The relationship between the peak shift and the residual stress, σ, is given by

$$σ = \frac{E}{( 1 + υ ) {sin}^{2} ψ} \cdot \frac{( {d}_{n} - {d}_{0} )}{{d}_{0}} ,$$

where E is Young's modulus, ν is Poisson's ratio, ψ is the tilt angle, and dₙ are the d spacing measured at each tilt angle.

If shear strains are not present in the specimen, the d spacing changes linearly with sin² ψ. d₀ is the inter-planar spacing when the substrate material is free from stresses. Calculations are performed for a Zr₃O peak taking place at 63.106°, which corresponds to the (113) plane with an inter-planar spacing of 0.1472 nm. The slope of linear dependence curve of d(113) with sin² ψ is −1.896×10⁻³±6.62×10⁻⁵ nm, and the intercept is 0.1472±4.75×10⁻³ nm. The elastic modulus and Poisson's ratio of zirconia are 2.20×10¹¹ Pa and 0.27, respectively. Thus, the residual stress, determined from the XRD technique at the surface vicinity from the above equation, is on the order of −1.4±0.05 GPa. Residual stress measurements were repeated three times and the error related to the measurements was on the order of 3%. Although the workpiece surface expands freely during the laser ablation/melting process, the surface vicinity is not free to expand and compressive stresses are formed. In addition, during laser scanning, the self-annealing effect was created, however, this effect does not significantly alter the stress levels at the surface because of the convective cooling of the assisting gas. Therefore, the residual stress remains high in the surface region. It should be noted that the residual stress measured is limited to the surface vicinity, since the penetration depth of the X-ray radiation is on the order of a few

FIG. 5 shows the scratch test results used to determine the friction coefficient of the laser ablated/melted and “as received” (i.e., untreated) surfaces. The surface friction coefficient remains low for the laser ablated/melted surface, which is associated with the microhardness enhancement and the presence of the hard particles at the laser treated surface. It should be noted that no peeling and delamination of the surface was observed during and after the scratch tests.

It is to be understood that the present invention is not limited to the embodiments described above, but encompasses any and all embodiments within the scope of the following claims.

I claim:

1. A method of laser treating a zirconia surface, comprising the steps of:
providing a phenolic resin and hard particle mixture, the phenolic resin and hard particle mixture including a phenolic resin and a mixture of at least two chemically different hard particles;
applying the phenolic resin and hard particle mixture to the zirconia surface to form a resin-coated zirconia surface;
heating the resin-coated zirconia surface to form a carbon-coated zirconia surface, the carbon-coated zirconia surface including a carbon film; and
scanning the carbon-coated zirconia surface with a nitrogen gas-assisted CO₂ laser beam to provide a laser-treated surface, the laser-treated surface including ZrN.

2. The method of laser treating a zirconia surface as recited in claim 1, wherein the at least two chemically different hard particles include titanium carbide (TiC) and boron carbide (B₄C).

3. The method of laser treating a zirconia surface as recited in claim 1, wherein the hard particle mixture includes titanium carbide (TiC) and boron carbide (B₄C) in a ratio of about 3 wt % of TiC and 3 wt % of B₄C.

4. The method of laser treating a zirconia surface as recited in claim 1, wherein the carbon film has a thickness of about 40 μm.

5. The method of laser treating a zirconia surface as recited in claim 1, wherein the step of heating the resin-coated zirconia surface comprises heating the resin-coated zirconia surface at a temperature of about 175° C. and a pressure of about 8 bar.

6. The method of laser treating a zirconia surface as recited in claim 5, wherein the step of heating the resin-coated zirconia surface further comprises heating the resin-coated zirconia surface at a temperature of about 400° C. in an inert gas atmosphere.

7. A method of laser treating a zirconia surface, comprising the steps of:
providing a phenolic resin and hard particle mixture, the phenolic resin and hard particle mixture including a phenolic resin and a mixture of titanium carbide (TiC) and boron carbide (B₄C);
applying the phenolic resin and hard particle mixture to an ytrria-stabilized zirconia surface to form a resin-coated zirconia surface;
heating the resin-coated zirconia surface to form a carbon-coated zirconia surface, the carbon-coated zirconia surface including a carbon film having a thickness of about 40 μm; and
scanning the carbon-coated zirconia surface with an inert gas-assisted CO₂ laser beam to provide a laser-treated surface.

8. The method of laser treating a zirconia surface as recited in claim 7, wherein the particles of titanium carbide (TiC) and boron carbide (B₄C) each have a diameter of about 600 nm.

9. The method of laser treating a zirconia surface as recited in claim 7, wherein the mixture of titanium carbide (TiC) and boron carbide (B₄C) includes about 3% titanium carbide (TiC) and about 3% boron carbide (B₄C).

10. The method of laser treating a zirconia surface as recited in claim 7, wherein the step of heating the resin-coated zirconia surface comprises heating the resin-coated zirconia surface at a temperature of about 175° C. and a pressure of about 8 bar.

11. The method of laser treating a zirconia surface as recited in claim 10, wherein the step of heating the resin-coated zirconia surface further comprises heating the resin-coated zirconia surface at a temperature of about 400° C. in an inert gas atmosphere.

12. A method of laser treating a zirconia surface, comprising the steps of:
providing a phenolic resin and hard particle mixture, the phenolic resin and hard particle mixture including a phenolic resin and a mixture of titanium carbide (TiC) and boron carbide (B₄C), the mixture of titanium carbide (TiC) and boron carbide (B₄C) including about 3% titanium carbide (TiC) and about 3% boron carbide (B₄C);
applying the phenolic resin and hard particle mixture to an ytrria-stabilized zirconia surface to form a resin-coated zirconia surface;
heating the resin-coated zirconia surface to form a carbon-coated zirconia surface, the carbon-coated zirconia surface including a carbon film; and
scanning the carbon-coated zirconia surface with an inert gas-assisted CO₂ laser beam to provide a laser-treated surface, the laser treated surface being a hydrophobic surface.

13. The method of laser treating a zirconia surface as recited in claim 12, wherein the particles of titanium carbide (TiC) and boron carbide (B₄C) each have a diameter of about 600 nm.

14. The method of laser treating a zirconia surface as recited in claim 12, wherein the step of heating the resin-coated zirconia surface comprises heating the resin-coated zirconia surface at a temperature of about 175° C. and a pressure of about 8 bar.

15. The method of laser treating a zirconia surface as recited in claim 14, wherein the step of heating the resin-coated zirconia surface further comprises heating the resin-coated zirconia surface at a temperature of about 400° C. in an inert gas atmosphere.
